(19) United States
(12) Patent Application Publication
(10) Pub. No.: US 2010/0256292 A1
(43) Pub. Date: Oct. 7, 2010

(54) CROSSLINKABLE POLYMER DISPERSIONS, COATING COMPOSITIONS COMPRISING THEM AND USE THEREOF

(75) Inventors: Martin Jakob, Kelkheim (DE); Ulrich Desor, Idstein (DE); Ivan Cabrera, Dreieich (DE)

Correspondence Address: DORITY & MANNING, P.A., POST OFFICE BOX 1449, GREENVILLE, SC, 29602-1449, US

(73) Assignee: CELANESE EMULSIONS GMBH, Kronberg/Ts (DE)

(21) Appl. No.: 12/665,340

(22) PCT Filed: May 26, 2008
(86) PCT No.: PCT/EP2008/004191

§ 371 Date: May 17, 2010

(30) Foreign Application Priority Data
Jun. 22, 2007 (DE) 10 2007 028 917.2

(51) Int. Cl. C08L 39/00; C08L 33/04; C08L 25/00; C08L 33/14; C08L 75/02

(52) U.S. Cl. 524/548; 524/559; 524/563; 524/556; 524/577; 524/558; 524/555

(57) ABSTRACT

What are described are alkalified compositions comprising an aqueous dispersion of selected polymers, and comprising selected polyaldehydes as crosslinking agents.

From these formulations it is possible to produce coating compositions having a very high blocking resistance and having excellent mechanical properties.

The present invention relates to polymer dispersions with selected polyaldehydes as crosslinking agents. From these it is possible to formulate preferably aqueous coating compositions, especially polyacrylate-based compositions, the films of which exhibit increased blocking resistance and excellent mechanical properties. The invention relates further to coating compositions comprising these polymer dispersions and also to their use to coat substrates.

Aqueous polymer dispersions, especially those based on polyacrylates, polyvinyl esters or polyvinylaromatics, are used in many fields in the prior art. Such polymer dispersions find application, for example, as binders for emulsion paints and also as white glues for bonding wood and other porous substrates.

An important performance property of films formed from polymer dispersions is their blocking resistance, i.e., the tendency to form tack-free films. It is already known that the blocking resistance of films formed from polymer dispersions can be improved by means of crosslinking. A variety of crosslinking systems are customary for this purpose. One of these systems uses acetoacetyl groups, which are incorporated into the polymer by copolymerization and are consumed by reaction with suitable polyfunctional components having a crosslinking action.

Also known is the addition of polyfunctional aldehydes for the purpose of improving the water resistance of polymer dispersions. In U.S. Pat. No. 3,932,335, glyoxal is added in combination with water-soluble polyols to give polyvinyl ester dispersions which produce water-resistant adhesive bonds.

EP-A-191,460 describes polyvinyl acetate dispersions stabilized with polyvinyl alcohol, said dispersions being crosslinked with glutaraldehyde and forming films that are resistant to boiling water over a period of at least 30 minutes.

WO-A-98/12,237 describes self-crosslinking aqueous dispersions. These dispersions, in addition to selected vinyl polymer component, comprise crosslinkers, additives, and solvents. Crosslinkers disclosed are aliphatic dialdehydes, such as glyoxal, and cyclic dialdehydes, such as furaldehydes, or dialkoxyfurans or -pyrans. The dispersions can be used as backing coatings or as binders.

DE-A-198 30 555 describes the use of aqueous polymer preparations comprising a film-forming polymer in the form of a dispersion for the coating of polyurethane-containing substrates. Polymers are used that comprise groups derived from ethylenically unsaturated ureas, thioureas or their cyclic derivatives, copolymerized with acrylates, vinyl esters or vinylaromatics, in combination with dialdehydes or polyaldehydes. As well as aliphatic dialdehydes, terephthalaldehyde is proposed. These systems crosslink in an alkaline medium.

There is still a need for dispersions from which films can be produced that have high blocking resistance and excellent mechanical properties.

It has now been found that this object can be achieved by selected polymer dispersions.

The invention relates to an aqueous polymer dispersion having a pH of greater than 7, comprising a) at least one film-forming polymer derived from at least two different free-radically polymerizable, ethylenically unsaturated monomers, of which the first monomer is selected from the group consisting of monoesters or diesters of α,β-ethylenically unsaturated mono-carboxylic or dicarboxylic acids with alkanols, of vinyl esters or of vinylaromatics, and the second monomer is an α,β-ethylenically unsaturated compound which has a group which is reactive with aldehydes in an alkaline medium, and comprising b) at least one stabilizer, and also c) at least one cycloaliphatic hydrocarbon having two to six aldehyde groups.

The polymer dispersions of the invention can be used as one-component or as multicomponent formulations. One-component formulations, surprisingly, exhibit sufficient shelflife and in general crosslink only after the polymer film has formed. Where the polymer dispersion of the invention takes the form of a multicomponent formulation comprising at least two components, A) and B), the copolymer a) and the stabilizer b) are used in component A), and the cyclo-aliphatic aldehyde c) in component B).

The invention also provides the crosslinkable composition comprising a), b) and c), and also the crosslinked product obtainable therefrom.

The emulsion polymers which are used as the polymer basis in the compositions of the invention are constructed substantially on the basis of one or more ethylenically unsaturated compounds; preference is given to polymers derived from esters of α,β-ethylenically unsaturated C₃-C₈ monocarboxylic or dicarboxylic acids and/or from vinyl esters and/or from alkenylaromatics.

Contemplated as a basis for the stated classes of polymer are, in principle, the following groups of monomers:

One group is formed by vinyl esters of monocarboxylic acids having one to eighteen carbon atoms, examples being vinyl formate, vinyl acetate, vinyl propionate, vinyl isobutyrate, vinyl valerate, vinyl pivalate, vinyl 2-ethylhexanoate, vinyl decanoate, isopropenyl acetate, vinyl esters of saturated branched monocarboxylic acids having 5 to 15 carbon atoms in the acid radical, especially vinyl esters of Versatic™ acids, vinyl esters of relatively long-chain saturated or unsaturated fatty acids such as, for example, vinyl laurate, vinyl stearate, and also vinyl esters of benzoic acid and of substituted derivatives of benzoic acid, such as vinyl p-tert-butylbenzoate. Among these, however, vinyl acetate is a particularly preferred principal monomer.

A further group of monomers which can be used in addition to the vinyl esters and/or esters of α,β-ethylenically unsaturated C₃-C₈ monocarboxylic or dicarboxylic acids and/or alkenylaromatics is formed by aliphatic, monoolefinically or diolefinically unsaturated, optionally halogen-substituted hydro-carbons, such as ethene, propene, 1-butene, 2-butene, isobutene, conjugated C₄-C₈ dienes, such as 1,3-butadiene, isoprene, chloroprene, vinyl chloride, vinylidene chloride, vinyl fluoride or vinylidene fluoride.

A further group of monomers is formed by esters of α,β-ethylenically unsaturated C₃-C₈ monocarboxylic or dicarboxylic acids with preferably C₁-C₁₈ alkanols and especially C₁-C₈ alkanols or C₅-C₈ cycloalkanols. The esters of dicarboxylic acids may be monoesters or, preferably, diesters. Examples of suitable C₁-C₈ alkanols are methanol, ethanol, n-propanol, isopropanol, 1-butanol, 2-butanol, isobutanol, tert-butanol, n-hexanol, and 2-ethylhexanol. Examples of suitable cycloalkanols are cyclopentanol or cyclohexanol. Examples are esters of acrylic acid, methacrylic acid, crotonic acid, maleic acid, itaconic acid, citraconic acid or fumaric acid such as methyl(meth)acrylate, ethyl(meth)acrylate, isopropyl(meth)acrylate, n-butyl(meth)acrylate, isobutyl(meth)acrylate, 1-hexyl(meth)acrylate, tert-butyl(meth)acrylate, 2-ethylhexyl(meth)acrylate, di-n-methyl maleate or fumarate, di-n-ethyl maleate or fumarate, di-n-propyl maleate or fumarate, di-n-butyl maleate or fumarate, diisobutyl maleate or fumarate, di-n-pentyl maleate or fumarate, di-n-hexyl maleate or fumarate, dicyclohexyl maleate or fumarate, di-n-heptyl maleate or fumarate, di-n-octyl maleate or fumarate, di(2-ethylhexyl) maleate or fumarate, di-n-nonyl maleate or fumarate, di-n-decyl maleate or fumarate, di-n-undecyl maleate or fumarate, dilauryl maleate or fumarate, dimyristyl maleate or fumarate, dipalmitoyl maleate or fumarate, distearyl maleate or fumarate, and diphenyl maleate or fumarate. This group of principal monomers is particularly preferred, since the copolymers prepared from them generally have a high resistance in the alkaline range.

A further group of monomers is formed by the alkenyl-aromatics. These are monoalkenylaromatics. Examples thereof are styrene, vinyltoluene, vinylxylene, α-methylstyrene or o-chlorostyrene. This group of principal monomers is also particularly preferred, since the copolymers prepared from them generally have a high resistance in the alkaline range.

The stated monomers generally form the principal monomers, which, in relation to the total amount of the monomers to be polymerized by the process of free-radical aqueous polymerization, normally account for a fraction of more than 50% by weight, preferably more than 75%.

The monomers are to be selected so as to form a copolymer which is stable in the alkaline medium of the polymer dispersion. In certain cases, copolymers based on vinyl esters do not exhibit sufficient stability. The skilled worker, however, is able to determine suitable systems by means of routine experiments.

Preferred principal monomers are constructed on the basis of the following classes of polymer:

Homopolymers or copolymers of one or more vinyl esters, especially of vinyl acetate; copolymers of vinyl esters with esters of α,β-ethylenically unsaturated C₃-C₈ monocarboxylic or dicarboxylic acids with C₁-C₈ alkanols, especially esters of (meth)acrylic acid and maleic acid or fumaric acid; copolymers of vinyl esters, especially vinyl acetate, with ethene; terpolymers of vinyl esters, ethene, and esters of α,βethylenically unsaturated C₃-C₈ monocarboxylic or dicarboxylic acids with C₁-C₈ alkanols, especially esters of (meth)acrylic acid and maleic acid or fumaric acid; homopolymers or copolymers of esters of (meth)acrylic acid; copolymers of styrene with butadiene and/or esters of α,β-ethylenically unsaturated C₃-C₈ monocarboxylic or dicarboxylic acids with C₁-C₈ alkanols, especially esters of (meth)acrylic acid.

Besides the principal monomers, the copolymers used in accordance with the invention derive from at least one second monomer, which gives the copolymer the desired crosslinkability with aldehydes. The second monomer is an α,β-ethylenically unsaturated compound which has a group which is reactive with aldehydes in an alkaline medium.

The monomers in question are preferably monomers selected from the group consisting of ethylenically unsaturated monomers comprising a 1,3-diketo group, preferably an acetoacetyl group, or ethylenically unsaturated monomers comprising an N-functional group, preferably ethylenically unsaturated monomers comprising an imidazolinone radical, or ethylenically unsaturated monomers comprising a urea radical.

Examples of such compounds of the formulae Ia, Ib, Ic, and Id

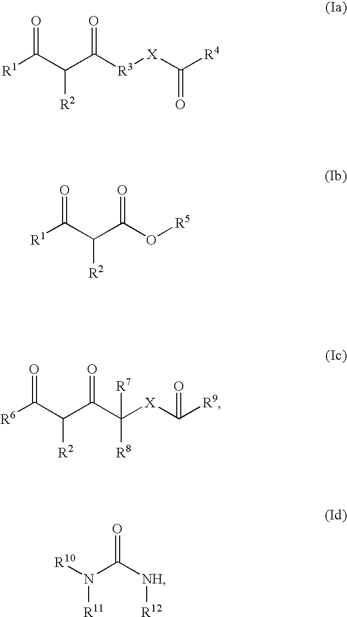

in which R¹ is a C₁-C₅ alkyl radical, preferably methyl,
R² is a C₁-C₅ alkyl radical or, preferably, hydrogen,
R³ is a C₁-C₅ alkylene radical, and
R⁴ is the radical of a ethylenically unsaturated organic carboxylic acid after the removal of the carboxyl group, preferably a radical of acrylic acid or of methacrylic acid following removal of the carboxyl group,
X is oxygen or NR¹³, with R¹³ being hydrogen or C₁-C₅ alkyl,
R⁵ is vinyl or allyl,
R⁶ is a C₁-C₅ alkyl radical, preferably methyl,
R⁷ and R⁸ independently of one another are hydrogen or a C₁-C₅ alkyl radical, preferably in each case methyl,
R⁹ is a radical of an ethylenically unsaturated organic carboxylic acid after the removal of the carboxyl group, preferably a radical of acrylic acid or methacrylic acid following removal of the carboxyl group,
R¹⁰ is a monoethylenically unsaturated radical having 2-20 C atoms, and
R¹¹ and R¹² independently of one another are hydrogen or C₁-C₅ alkyl or together form a C₂-C₄ alkylene group which is unsubstituted or substituted once or twice by C₁-C₅ alkyl, C₁-C₄ alkoxy and/or hydroxyl.

Second monomers used with particular preference are ethylenically unsaturated compounds which are self-crosslinking or can be crosslinked with the polyaldehyde via CH acidic carbonyl groups in the basic range. Examples are allyl acetoacetate, vinyl acetoacetate, and acetoacetoxyethyl acrylate or methacrylate

Further second monomers used with particular preference are ethylenically unsaturated compounds which are self-crosslinking or can be crosslinked via urea radicals or via imidazolinone radicals in the basic range. Examples are N-vinylethyleneurea, N-((meth)acryloyloxyacetoxy-ethyl)ethyleneurea, N-(2-(meth)acryloyloxyethyl)-ethyleneurea, N-[(3-allyloxy-2-hydroxypropyl)amino-ethyl]ethyleneurea, N-(acrylamidoethyl)ethyleneurea, N-(methacrylamidoethyl)ethyleneurea, N-allylethyleneurea, N-(2-methacryloyloxyacetamidoethyl)ethyleneurea, N-(2-methacryloyloxyethyl)ethyleneurea.

Further ethylenically unsaturated monomers with N-functional groups that are used with particular preference as second monomers are (meth)acrylamide, allyl carbamate, acrylonitrile, methacrylonitrile, N-methylol(meth)acrylamide, N-methylolallyl carbamate, and also the N-methylol esters, N-alkyl ethers or Mannich bases of N-methylol(meth)acrylamide or N-methylolallyl carbamate, acrylamidoglycolic acid, methyl acrylamidomethoxyacetate, N-(2,2-dimethoxy-1-hydroxyethyl)acrylamide, N-dimethylaminopropyl(meth)-acrylamide, N-methyl(meth)acrylamide, N-butyl(meth)-acrylamide, N-cyclohexyl(meth)acrylamide, N-dodecyl-(meth) acrylamide, N-benzyl(meth)acrylamide, p-hydroxy-phenyl(meth)acrylamide, N-(3-hydroxy-2,2-dimethyl-propyl)methacrylamide, N-vinylformamide or N-vinyl-pyrrolidone.

The second monomer is used in an amount, based on the total amount of the monomers to be polymerized, of less than 50% by weight, preferably at less than 30% by weight.

It will be appreciated that further comonomers which modify the properties in a targeted way can be used in the polymerization as well. Such auxiliary monomers are normally incorporated only as modifying monomers by copolymerization, in amounts, based on the total amount of the monomers to be polymerized, of less than 50% by weight, generally less than 20%, preferably at less than 10% by weight.

These monomers serve for further stabilization of the dispersions, may enhance film cohesion or other properties by crosslinking during polymerization or during film formation, and/or may react with the polyaldehyde c) with crosslinking, as a result of a suitable functionality.

Monomers which may serve for further stabilization are generally monomers which have an acid function and/or the salts thereof. This group includes, for example, α,β-monoethylenically unsaturated monocarboxylic and dicarboxylic acids having 3 to 10 C atoms, ethylenically unsaturated sulfonic acids, ethylenically unsaturated phosphonic acids or dihydrogenphosphates and their water-soluble salts, such as their sodium salts. Preferred monomers from this group are vinyl-sulfonic acid and its alkali metal salts, acrylamido-propanesulfonic acid and its alkali metal salts, ethylenically unsaturated C₃-C₈ carboxylic acids and C₄-C₈ dicarboxylic acids, examples being itaconic acid, crotonic acid, vinylacetic acid, acrylamidoglycolic acid, and especially acrylic acid and methacrylic acid.

Examples of crosslinking auxiliary monomers are monomers having two or more vinyl radicals, monomers having two or more vinylidene radicals, and monomers having two or more alkenyl radicals. Particularly advantageous in this context are the diesters of dihydric alcohols with α,β-monoethylenically unsaturated monocarboxylic acids, among which acrylic and methacrylic acid are preferred; the diesters of dibasic carboxylic acids with ethylenically unsaturated alcohols; other hydrocarbons having two ethylenically unsaturated groups; or the diamides of difunctional amines with α,β-monoethylenically unsaturated monocarboxylic acids.

Examples of monomers of this kind having two non-conjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates or dimethacrylates, and ethylene glycol diacrylates or dimethacrylates, 1,2-propylene glycol dimethacrylate, 1,3-propylene glycol dimethacrylate, 1,3-butylene glycol dimethacrylate, 1,4-butylene glycol dimethacrylates, hexanediol diacrylate, pentaerythritol diacrylate, and also divinylbenzene, vinyl methacrylate, vinyl acrylate, vinyl crotonate, allyl methacrylate, allyl acrylate, diallyl maleate, diallyl fumarate, diallyl phthalate, cyclopentadienyl acrylate, divinyl adipate or methylenebisacrylamide.

Also possible, however, is the use of monomers having more than two double bonds, examples being tetraallyl-oxyethane, trimethylolpropane triacrylate or triallyl cyanurate.

A further group of auxiliary monomers is formed by hydroxy-functional monomers such as the C₁-C₉ hydroxyalkyl esters of methacrylic acid and acrylic acid, such as n-hydroxyethyl, n-hydroxypropyl or n-hydroxybutyl acrylate and methacrylate, and the adducts thereof with ethylene oxide or propylene oxide.

A further group of auxiliary monomers is composed of monomers containing silane groups, vinyltrialkoxy-silanes for example, such as vinyltrimethoxysilane, vinyltriethoxysilane, alkylvinyldialkoxysilanes or (meth)acryloyloxyalkyltrialkoxysilanes, such as (meth)-acryloyloxyethyltrimethoxysilane, or (meth)acryloyloxy-propyltrimethoxysilane.

A further group of auxiliary monomers is composed of monomers containing epoxy groups, such as, for example, allyl glycidyl ether, methacryloyl glycidyl ether, butadiene monoepoxides, 1,2-epoxy-5-hexene, 1,2-epoxy-7-octene, 1,2-epoxy-9-decene, 8-hydroxy-6,7-epoxy-1-octene, 8-acetoxy-6,7-epoxy-1-octene, N-(2,3-epoxy)-propylacrylamide, N-(2,3-epoxy)propylmethacrylamide, 4-acrylamidophenyl glycidyl ether, 3-acrylamidophenyl glycidyl ether, 4-methacrylamidophenyl glycidyl ether, 3-methacrylamidophenyl glycidyl ether, N-glycidyloxy-methylacrylamide, N-glycidyloxypropylmethacrylamide, N-glycidyloxyethylacrylamide, N-glycidyloxyethyl-methacrylamide, N-glycidyloxypropylacrylamide, N-glycidyloxypropylmethacrylamide, N-glycidyloxybutyl-acrylamide, N-glycidyloxybutylmethacrylamide, 4-acrylamidomethyl-2,5-dimethylphenyl glycidyl ether, 4-methacrylamidomethyl-2,5-dimethylphenyl glycidyl ether, acrylamidopropyldimethyl(2,3-epoxy)propyl-ammonium chloride, methacrylamidopropyldimethyl(2,3-epoxy)propylammonium chloride, and glycidyl methacrylate.

Besides the copolymer, the dispersions of the invention comprise stabilizers. These are ionic emulsifiers and/or nonionic emulsifiers and/or protective colloids.

As emulsifiers it is possible to use the ionic, preferably anionic, or nonionic emulsifiers that are known per se and are customary. A listing of suitable emulsifiers is found in Houben-Weyl, Methoden der organischen Chemie, Volume XIV/I, Makromeolekulare Stoffe [Macromolecular compounds], Georg-Thieme Verlag, Stuttgart, 1961, pp. 192-208.

Examples of nonionic emulsifiers are acyl, alkyl, oleyl and alkylaryl ethoxylates. These products are available, for example, commercially under the name Genapol® or Lutensol®. These include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄ fatty alcohol (3-8)ethoxylates, C₁₃-C₁₅ oxo-process alcohol (3-30)ethoxylates, C₁₆C₁₈ fatty alcohol (11-80)ethoxylates, C₁₀ oxo-process alcohol (3-11)ethoxylates, C₁₃ oxo-process alcohol (3-20)ethoxylates, poly-oxyethylenesorbitan monooleate with 20 ethylene oxide groups, copolymers of ethylene oxide and propylene oxide with a minimum ethylene oxide content of 10% by weight, the polyethylene oxide (4-20) ethers of oleyl alcohol, and the polyethene oxide (4-20) ethers of nonylphenol. Particularly suitable are the polyethylene oxide (4-20) ethers of fatty alcohols, particularly of oleyl alcohol.

Examples of anionic emulsifiers are salts of bis-esters of sulfonated dicarboxylic acids having 4 to 8 carbon atoms, such as sulfonated salts of esters of succinic acid, example being alkali metal salts of sulfosuccinic esters with aliphatic saturated monovalent alcohols of chain length C₄-C₁₆, 4-sulfo-succinic esters with polyethylene glycol ethers of monohydric aliphatic alcohols of chain length C₁₀-C₁₂ (disodium salt), 4-sulfosuccinic esters with poly-ethylene glycol nonylphenyl ether (disodium salt) or bis-cyclohexyl sulfosuccinate (sodium salt).

Further examples of anionic emulsifiers are sodium, potassium, and ammonium salts of straight-chain aliphatic carboxylic acids of chain length C₁₂-C₂₀, sodium hydroxyoctadecanesulfonate, sodium, potassium, and ammonium salts of hydroxy fatty acids of chain length C₁₂-C₂₀ and the sulfonation and/or acetylation products thereof, alkyl sulfates, including those in the form of triethanolamine salts, alkyl(C₁₀-C₂₀)-sulfonates, alkyl(C₁₀-C₂₀)-arylsulfonates, dimethyldi-alkyl(C₈-C₁₈)-ammonium chloride, and their sulfonation products, lignosulfonic acid and its calcium, magnesium, sodium, and ammonium salts, resin acids, hydrogenated and dehydrogenated resin acids and also their alkali metal salts, dodecylated diphenyl ether disulfonate sodium, and also sodium lauryl sulfate, or ethoxylated sodium lauryl ether sulfate (EO degree 3)

Protective colloids which can be used are the polymeric compounds which are known per se and customary. These colloids are generally present during the actual emulsion polymerization.

Examples of suitable protective colloids include polyvinyl alcohols, polyalkylene glycols, alkali metal salts of polyacrylic acids and polymethacrylic acids, cellulose derivatives, starch derivatives, and gelatin derivatives, or polymers derived from acrylic acid, methacrylic acid, maleic acid, maleic anhydride, methyl vinyl ether, styrene, 2-acrylamido-2-methylpropane-sulfonic acid and/or 4-styrenesulfonic acid, and alkali metal salts thereof, and also polymers derived from N-vinylpyrrolidone, N-vinylcaprolactam, N-vinyl-carbazole, 1-vinylimidazole, 2-vinylimidazole, 2-vinyl-pyridine, 4-vinylpyridine, acrylamide, methacrylamide, amino-group-bearing acrylates, methacrylates, acrylamides and/or methacrylamides. A comprehensive description of other suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pages 411 to 420.

Where the protective colloids are polyvinyl alcohol, use is made in particular of polyvinyl alcohol with a degree of hydrolysis of 60-100 mol %, preferably 70 to 98 mol %, and with viscosities of the 4% strength by weight aqueous solutions at 20° C. of 2 to 70 mPa*s, or mixtures of these types. As well as “homopolymeric” polyvinyl alcohol, i.e., polyvinyl alcohol composed only of vinyl alcohol groups and residual vinyl acetate groups, it is possible to use copolymeric and/or functionalized polyvinyl alcohols, examples being reaction products of polyvinyl alcohol with diketene or with polyvinyl alcohol types which carry carboxyl groups, thiol groups, formamido groups, amino groups, arylamino groups, sulfate groups, sulfonate groups, phosphonate groups, quaternary ammonium groups, and other functional groups.

The stated stabilizers, i.e., the emulsifiers and/or protective colloids, can also be added to the dispersion, if desired, during the polymerization or after the polymerization.

Based on the solids fraction of the polymer dispersion, the fraction of the polymeric protective colloids may be up to 35% by weight, more particularly 1% to 20% by weight.

The fraction of the emulsifiers may be up to 10% by weight, based on the solids fraction of the polymer dispersion. Emulsifiers may be present during the actual polymerization and/or may be added subsequently.

Preferred dispersions are those without protective colloids but with up to 3% by weight, based on the solids fraction of the polymer dispersion, of anionic and/or nonionic emulsifiers.

The copolymer has groups which are crosslinkable with aldehydes and which derive from the second monomer defined above. These groups are, for example, activated methylene groups, amino groups, amido groups, ureido groups, and in this case preferably imidazolinone groups.

Polyaldehydes used in accordance with the invention are cycloaliphatic hydrocarbons having two to six aldehyde groups.

The cycloaliphatic polyaldehydes used in the polymer dispersions of the invention derive from monocyclic or polycyclic, preferably bicyclic, hydrocarbons. Examples of monocyclic hydrocarbons are cyclopentane, cyclohexane, cycloheptane, and cyclooctane. Examples of bicyclic hydrocarbons are norbornane, norbornene or tricyclodecane (“TCD”). These polyaldehydes have, in particular, two to four aldehyde groups. These groups may be covalently bonded to the cycloaliphatic nucleus directly or via a bridging group, an alkylene group, for example. Examples of preferred compounds of this type are cyclohexanedialdehyde, cyclopentanedialdehyde, vinylcyclohexanedialdehyde, norbornanedialdehyde, norbornenedialdehyde, ethylnorbornanedialdehyde or, with particular preference, 3(4),8(9)-bis(formyl)tri-cyclo[5.2.1.0^{2,6}]decane or “tricyclodecane dialdehyde” (=“TCD dialdehyde”).

These preferred dialdehydes have the following structures of the formulae II to X

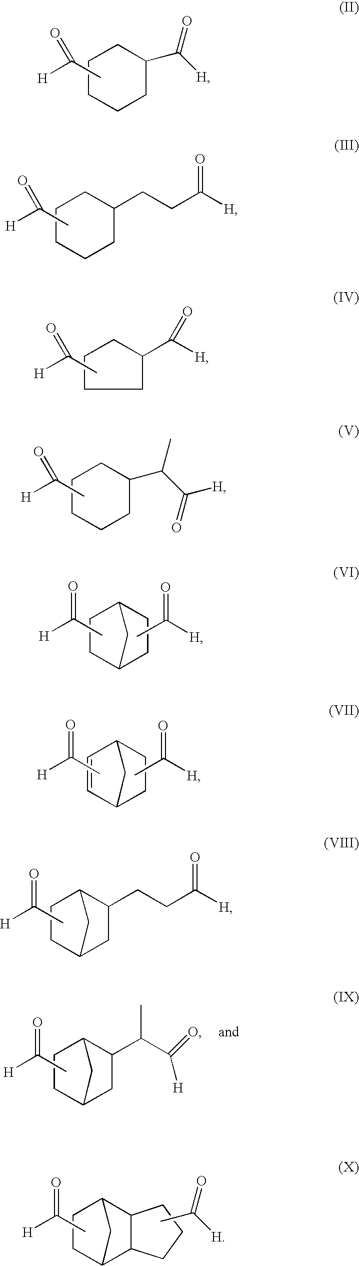

The polyaldehydes used in accordance with the invention are compounds which are known per se, some of which are available commercially, or which can be prepared by known methods of organic chemistry.

The dialdehydes of monocyclic or bicyclic hydrocarbons that are recited above as being particularly preferred may be prepared, for example, by hydroformylation of the corresponding alkenyl compounds.

For example, the TCD dialdehyde used with particular preference may be prepared by the method known from US-A-2005/0101805.

The amount of polyaldehydes used is 0.001% to 25% by weight, based on the solids of the polymer dispersion, and is dependent on the nature of the polyaldehyde used and also on the composition of the dispersion.

The preferred range is between 0.01% and 30% by weight, more particularly between 0.1% and 25% by weight, based on the solids of the polymer dispersion.

The polymer dispersion of the invention may comprise further, customary additives, as are used typically in paint formulas or other building-material formulations. They include, for example, film-forming assistants for lowering the minimum film formation temperature (“MFFT reducers”), plasticizers, buffers, pH modifiers, dispersants, defoamers, fillers, dyes, pigments, silane coupling agents, thickeners, viscosity regulators, solvents and/or preservatives and external crosslinking agents, such as crosslinker resins, for example.

The polymer dispersion of the invention possesses an alkaline pH which is situated within a range in which the aldehyde groups of the cycloaliphatic polyaldehyde are capable of crosslinking reactions with the reactive groups of the second monomer. This pH range is preferably between 7.1 and 14, more particularly between 8.5 and 11.5. A suitable pH may be achieved after the emulsion polymerization for the preparation of the polymer dispersion, or can be brought about subsequently by addition of basic compounds. In order to bring the pH in the target basic range, organic or inorganic Lewis and Br⊂nsted bases are suitable. Examples of suitable bases are aqueous sodium or potassium hydroxide solution, waterglass, ammonia, primary, secondary or tertiary amines, amino alcohols, such as AMP 90, for example, or alkali metal carbonates or bicarbonates, such as Na₂CO₃ or NAHCO₃.

Preference is given to multicomponent compositions in which at least component A, preferably the mixture of component A and B, has a pH of 7.1 to 14, more particularly between 8.5 and 11.5.

In one specific embodiment of the multicomponent formulations of the invention, components A) and B) are preformulated and the aforementioned pH modifiers are added subsequently to the combined components A) and B).

The solids content of the polymer dispersion of the invention is preferably 20% to 70% by weight, more particularly 30% to 65% by weight.

The polymer dispersion is prepared by the customary continuous or discontinuous procedures of free-radical emulsion polymerization. The emulsion polymerization may take place in one stage or, preferably, in a multiplicity of stages. The multistage polymers used with preference are notable for particularly advantageous blocking resistance and also excellent mechanical properties of the films.

The implementation of a free-radically initiated aqueous emulsion polymerization of ethylenically unsaturated monomers has been described many times before now and is therefore well known to the skilled worker [cf., e.g., Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2^{nd} Edition, Vol. I, pages 33 to 415, Chapman & Hall, 1997; H. Warson, The Applications of Synthetic Resin Emulsions, pages 49 to 244, Ernest Bonn. Ltd. London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Hölscher, Dispersionen synthetischer Hochpolymerer, pages 1 to 160, Springer-Verlag, Berlin, 1969, and patent specification DE-A 40 03 422]. It takes place customarily by dispersing the ethylenically unsaturated monomers in the aqueous medium, frequently with accompanying use of dispersing assistants, and polymerizing them by means of at least one free-radical polymerization initiator.

Employed in this context are water-soluble and/or oil-soluble initiator systems such as peroxodisulfates, azo compounds, hydrogen peroxide, organic hydroperoxides or dibenzoyl peroxide. They can be used either on their own or in combination with reducing compounds such as Fe(II) salts, sodium pyrosulfite, sodium hydrogen sulfite, sodium sulfite, sodium dithionite, sodium formaldehyde-sulfoxylate, ascorbic acid as a redox catalyst system.

The polymeric protective colloids and/or emulsifiers b) may be added before or during the polymerization. The further addition of polymeric stabilizers and/or of emulsifiers subsequently is likewise possible. This dispersion is then further admixed, where appropriate, with the additives intended for the desired end-use application.

The compositions of the invention can be formulated in the apparatus known for that purpose to the skilled worker, such as, for example, in stirred tanks or suitable mixers. Mixing of the components only shortly prior to application, by means of suitable apparatus, for example, is a possibility.

After a film has been formed from the polymer, the composition of the invention cures to give the product cured in accordance with the invention. The rate of cure may be influenced through a suitable selection of the formulation.

The curable compositions of the invention can be processed to films having a very high blocking resistance. Without being tied to any one theory it is assumed that the structural peculiarity of the hydrophobic polyaldehydes has a positive influence on the blocking resistance.

The aqueous polymer dispersions of the invention can be used as binders for coating compositions of all kinds.

The fraction of polymer dispersion in the coating composition of the invention is typically 5% to 50%, preferably 10% to 50%, more preferably 15% to 30%, by weight, based on the overall solids content.

The polymer dispersions of the invention are used, for example, as binders in preparations which serve for the coating of substrates. These include, for example, synthetic-resin-bound plasters, tile adhesives, sealants, and sealing compounds, preferably for porous components, and also paper-coating slips, but especially paints, such as emulsion paints, dispersion-based varnishes, and stains, for example.

With particular preference the polymer dispersions of the invention are used as roof coatings, as masonry paints or as interior paints.

The polymer dispersions can be used directly or following addition of rheology-modifying additives and/or other components as preparations for the coating of substrates. Such preparations are, for example, primers or clearcoat materials.

One preferred embodiment of the preparations are emulsion paints. They contain generally 30% to 75% by weight, preferably 40% to 65% by weight, of nonvolatile constituents. This refers to all constituents of the emulsion paint besides water and any hydrocarbons present—for example, the total amount of solid binder, filler, pigment, plasticizer, binder (solids fraction), and polymeric auxiliary.

Of the nonvolatile constituents, preferably
a) 3% to 90% by weight, more preferably 10% to 60% by weight, is accounted for by the polymer dispersion, the quantity figures being based on solids,
b) 5% to 85% by weight, more preferably 10% to 60% by weight, is accounted for by at least one inorganic pigment,
c) 0% to 85% by weight, more preferably 20% to 70% by weight, is accounted for by inorganic fillers, and
d) 0.1% to 40% by weight, more preferably 0.5% to 15% by weight, is accounted for by customary auxiliaries.

Particular preference is given to solvent-free and plasticizer-free, aqueous coating compositions.

The pigment/volume concentration (PVC) of pigmented coating compositions of the invention is generally above 5%, preferably in the range from 10% to 90%.

All of the pigments known to the skilled worker for the stated purposes of use may be used. Preference is given to titanium dioxide, preferably in the rutile form, barium sulfate, zinc oxide, zinc sulfide, basic lead carbonate, antimony trioxide, and lithopones (zinc sulfide and barium sulfate). Alternatively the coating compositions may comprise colored pigments, examples being iron oxides, carbon black, graphite, luminescent pigments, zinc yellow, zinc green, ultramarine, manganese black, antimony black, manganese violet, Paris blue or Schweinfurt green. Besides the inorganic pigments, the coating compositions of the invention may also comprise organic color pigments, examples being sepia, gamboge, Cassel brown, toluidine red, Para red, Hansa yellow, indigo, azo dyes, anthraquinonoid and indigoid dyes, and also dioxazine, quinacridone, phthalocyanine, isoindolinone, and metal-complex pigments.

As fillers it is possible to use all of the fillers that are known to the skilled worker for the stated purpose of use. Preferred fillers are aluminosilicates, such as feldspars, silicates, such as kaolin, talc, mica, china clay, magnesite, alkaline earth metal carbonates, such as calcium carbonate, in the form of calcite or chalk, for example, magnesium carbonate, dolomite, alkaline earth metal sulfates, such as calcium sulfate, and silicon dioxide. The fillers can be used either as individual components or as filler mixtures. Preference is given in practice to filler mixtures such as calcium carbonate/kaolin and calcium carbonate/talc, for example. Synthetic-resin-bound plasters may also comprise relatively large aggregates, such as sands or sandstone granules. In emulsion paints, preference is generally given to finely divided fillers.

In order to increase the hiding power and to save on white pigments, use is frequently made in emulsion paints of preferably finely divided fillers, such as precipitated calcium carbonate or mixtures of different calcium carbonates having different particle sizes, for example. To set the hiding power of the hue and the depth of color it is preferred to use blends of color pigments and fillers.

The customary assistants include wetting agents or dispersants, such as sodium, potassium or ammonium polyphosphates, alkali metal salts and ammonium salts of polyacrylic acids and of polymaleic acid, poly-phosphonates, such as sodium 1-hydroxyethane-1,1-diphosphonate, and also naphthalenesulfonic salts, particularly their sodium salts. Wetting agents which can be used are, additionally, suitable amino alcohols, such as 2-amino-2-methylpropanol, for example. The dispersants and wetting agents are used preferably in an amount of 0.1% to 2% by weight, based on the total weight of the coating composition.

The auxiliaries may also, furthermore, include thickeners, examples being cellulose derivatives, such as methylcellulose, hydroxyethylcellulose and carboxy-methylcellulose, and also casein, gum arabic, gum tragacanth, starch, sodium alginate, polyvinyl alcohol, polyvinylpyrrolidone, sodium polyacrylates, water-soluble copolymers based on acrylic and (meth)acrylic acid, such as acrylic acid/acrylamide copolymers and (meth)acrylic acid/acrylic ester copolymers, and what are called associative thickeners, such as styrene-maleic anhydride polymers or, preferably, hydrophobically modified polyetherurethanes (HEUR) which are known to the skilled worker, and hydrophobically modified acrylic acid copolymers (HASE) polyether polyols.

Inorganic thickeners as well, such as bentonites or hectorite, for example, may be used.

Where thickeners are present, they are used preferably in amounts of 0.1% to 3% by weight, more preferably 0.1% to 1% by weight, based on the total weight of the coating composition.

The coating compositions of the invention may also comprise further crosslinking additions. Such additions may include the following: aromatic ketones, such as alkyl phenol ketones, which if desired have one or more substituents on the phenyl ring, or benzophenone and substituted benzophenone photoinitiators. Photo-initiators suitable for this purpose are disclosed in DE-A-38 27 975 and EP-A-0 417 568, for example. Suitable compounds with a crosslinking action are also water-soluble compounds having at least two amino groups, examples being hydrazides of aliphatic dicarboxylic acids, as disclosed, for example, in DE-A-39 01 073.

As further auxiliaries the coating compositions of the invention may additionally comprise waxes based on paraffins and polyethylene, and also matting agents, defoamers, preservatives or water repellents, UV stabilizers, biocides, fibers, plasticizers, and other additives known to the skilled worker. Examples of plasticizers are dimethyl phthalate, diisobutyl phthalate, diisobutyl adipate, Coasol B®, and Plastilit 3060®. Examples of defoamers are mineral oil defoamers or silicone defoamers. Examples of UV stabilizers are sterically hindered piperidine compounds (HALS) or benzophenone derivatives.

The polymer dispersions of the invention may be used to prepare not only solvent-free and plasticizer-free coating compositions but also, of course, coating compositions which comprise solvents and/or plasticizers. Film-forming assistants of this kind are common knowledge to the skilled worker and can be used typically in amounts of 0.1% to 20% by weight, based on the polymer present in the preparation, so that the preparation has a minimum film formation temperature of less than 15° C., preferably in the range from 0 to 10° C. Examples of such are white spirit, Texanol®, TxiB®, butylglycol, butyldiglycol, butyldipropylene glycol, and butyltripropylene glycol.

The coating compositions of the invention are stable fluid systems which can be used to coat a multiplicity of substrates. Examples of suitable substrates include wood, concrete, metal, glass, ceramics, plastic, plasters, wallpapers, paper, coated, primed or weathered substrates. Application of the coating composition to the substrate that is to be coated takes place in a way which is dependent on the embodiment of the coating composition. Depending on the viscosity and pigment content of the preparation and also on the substrate, application may take place by roller, brush, knife-coater or in the form of spray.

The polymer dispersion of the invention can also be used to prepare redispersible dispersion powders. These powders can be produced in a conventional way by spraying of the polymer dispersion.

Surprisingly, the films generated from the coating compositions of the invention exhibit an extremely high blocking resistance, and also high tensile strengths and relatively low elongations at break.

The uses described above are likewise provided by the present invention.

The examples which follow serve to illustrate the invention. Unless otherwise indicated, the parts and percentages referred to in the examples are by weight.

### Base Dispersion A1

Mowilith® DM 777, commercial product of Celanese Emulsions GmbH, was used, being an aqueous polyacrylate dispersion prepared by single-stage emulsion polymerization and containing a small amount of structural units derived from allyl acetoxyacetate. The pH is 8.5.

The solids content of the dispersion is 46% by weight; the viscosity, determined by the Brookfield method, RVT 2/20, is 200±100 mPa*s.

### Base Dispersion A2

Mowilith® LDM 7411, commercial product of Celanese Emulsions GmbH, was used, being an aqueous polyacrylate dispersion prepared by two-stage emulsion polymerization and containing a small amount of structural units derived from acetoacetoxyethyl methacrylate. The pH is 8.5.

The solids content of the dispersion is 50% by weight; the viscosity, determined by the Brookfield method, RVT 3/20, is 2000 mPa*s.

### INVENTIVE EXAMPLES 1 TO 2 AND COMPARATIVE EXAMPLES C1 TO C4

### Inventive Example 1

Base dispersion A1 was mixed with 0.84 g of TCD dialdehyde. This gave a storage-stable dispersion with a pH of 8.02. The quantity figure for the TCD dialdehyde is based on 100 g of formulation employed.

### Inventive Example 2

Base dispersion A2 was mixed with 0.73 g of TCD dialdehyde. This gave a storage-stable dispersion with a pH of 7.75. The quantity figure for the TCD dialdehyde is based on 100 g of formulation employed.

### Comparative Example C1

Base dispersion A1 was used as the formulation. The pH was 8.16.

### Comparative Example C2

Base dispersion A2 was used as the formulation. The pH was 7.15.

### Comparative Example C3

Base dispersion A1 was mixed with 0.63 g of glyoxal 40. This gave a brown-colored dispersion of inadequate shelflife, with a pH of 7.73. The quantity figure for the glyoxal is based on 100 g of formulation employed.

### Comparative Example C4

Base dispersion A2 was mixed with 0.55 g of glyoxal 40. This gave a discolored dispersion of inadequate shelflife, with a pH of 7.87. The quantity figure for the glyoxal is based on the total amount of formulation employed.

### Mechanical Properties of Films Formed

From the dispersions of inventive examples 1 and 2 and also of comparative examples C1 to C4, films were produced and their elongations at break and tensile strengths were determined in accordance with DIN 53455. The films formed from the dispersion of comparative example C4 proved to be too brittle, and so under those conditions it was not possible to obtain any results. The results for certain formulations are set out in the table below.

| | Breaking | Tensile strength |
|---|---|---|
| Example | elongation (%) | (N/mm²) |
| C1 | 220 | 6.3 |
| C3 | 212 | 6.6 |
| 1 | 28 | 9.2 |

### Blocking Resistances of Films

Films were produced on glass slides, using the dispersions of inventive examples 1 and 2 and of comparative examples C1 to C4, and their blocking resistances were ascertained. This was done by applying the dispersions to slides, using a doctorblade, and drying the applied dispersions at room temperature for 4 days or 7 days. After that, pairs of slides were placed with their coated surfaces against one another and were loaded with a weight of 2 kg in a controlled-climate chamber at 50° C. for one hour. This was followed by a determination of the force needed to separate the two slides. The higher this force, the lower the blocking resistance of the films obtained. The results are set out in the table below.

| | Blocking resistance | Blocking resistance |
|---|---|---|
| | after 4 days of | after 7 days of |
| Example | drying (g/6.75 cm²) | drying (g/6.75 cm²) |
| C1 | 4531 | 4669 |
| C3 | 4347 | >5000 |
| 1 | 2950 | 2297 |
| C2 | 1669 | 1472 |
| C4 | 1476 | 1225 |
| 2 | 934 | 481 |

From these figures it is evident that the films formed from the dispersions of the invention are distinguished by very high blocking resistance (i.e., low release force).

### Blocking Resistances of Emulsion Paints

The invention is described in more detail below by formulation and investigation of emulsion paints whose composition is as detailed below:

| Ingredients | Parts by weight |
|---|---|
| Water | 13 |
| Propylene glycol | 40 |
| Dispersant | 8.0 |
| AMP 90 Wetting agent | 2.0 |
| Byk 044 | 2.0 |
| Titanium dioxide pigment | 210 |
| Ammonia, 25% strength | 3.0 |
| aqueous solution | |
| Copolymer dispersion¹⁾ | 58.0 |
| Methoxybutanol | 15.0 |
| Propylene glycol | 10.0 |
| Texanol | 20.0 |
| Sudranol 240 | 30.0 |
| Mowilith ® VDM 7000 | 20.0 |
| Water | 47.0 |
| Total | 1000.0 |

¹⁾The dispersions used are set out in the table below.

First of all a pigment paste was produced. For this purpose, water was introduced in a dissolver. Then the following were added: dispersant, wetting agent, Byk 044, propylene glycol, and titanium dioxide. The speed of the dissolver was increased until a pigment paste was formed.

For the preparation of the emulsion paint, the binder dispersion was introduced in a stirring vessel and the following ingredients were added in succession and with stirring: ammonia solution, pigment paste, mixture of methoxybutanol, propylene glycol, and Texanol, and Südranol 240. After a few minutes of stirring, water and Mowilith VDM 7000 were added with stirring, and the resulting emulsion paint was stirred subsequently for several minutes.

The emulsion paints obtained were applied to slides and their blocking resistances were ascertained. This was done by applying the dispersions to slides, using a doctorblade, and drying the applied dispersions at room temperature for 7 days. After that, pairs of slides were placed with their coated surfaces against one another and were loaded with a weight of 2 kg in a controlled-climate chamber at 50° C. for 1 hour. This was followed by a determination of the force needed to separate the two slides. The higher this force, the lower the blocking resistance of the films obtained. The results are set out in the table below.

| Emulsion paint with binder | Blocking resistance after 7 |
|---|---|
| of example | days of drying (g) |
| C1 | >5000 |
| C3 | 4370 |
| 1 | 2299 |
| C2 | 341 |
| C4 | 388 |
| 2 | 337 |

From these figures it is evident that the films formed from emulsion paints comprising binders comprising the dispersions of the invention are likewise distinguished by very high blocking resistance (i.e., low release force).

### Mechanical Properties of Stains

The invention is described in more detail below by formulation and investigation of stains whose composition is as detailed below:

| Ingredients | Parts by weight |
|---|---|
| Water | 33.5 |
| Copolymer dispersion (50% | 370.0 |
| form)¹⁾ | |
| Ammonia; 25% strength | 0.5 |
| aqueous solution | |
| Water | 34.8 |
| Preservative | 1.0 |
| Lopon 890 dispersant | 1.5 |
| Deaerating agent | 1.5 |
| Ammonia; 25% strength | 0.5 |
| aqueous solution | |
| Fumed silica | 10.0 |
| Thickener | 2.5 |
| Water | 7.7 |
| Dowanol PnB solvent | 15.0 |
| Deaerating agent | 1.5 |
| Lyconyl yellow pigment | 20 |
| Total | 500.0 |

¹⁾The dispersions used are set out in the table below.

The stains obtained were applied using a 1000 μm doctorblade to a glass plate coated with Teflon®. The water was evaporated by leaving the coated plate to stand at room temperature, and the film formed was removed. This was followed by determination of mechanical properties of the films in accordance with DIN 53455. The results are set out in the table below.

| Stain with binder | Elongation at | Tensile strength |
|---|---|---|
| of example | break (%) | (N/mm²) |
| C1 | 154 | 11.3 |
| C3 | 125 | 11.8 |
| 1 | 21 | 12.1 |
| C2 | 38 | 8.9 |
| C4 | 24 | 11 |
| 2 | 4 | 11.8 |

From these figures it is evident that the films formed from stains comprising binders comprising the dispersions of the invention are distinguished by low elongations at break and by very high tensile strengths.

1. An aqueous polymer dispersion having a pH of greater than 7, comprising a) at least one film-forming polymer derived from at least two different free-radically polymerizable, ethylenically unsaturated monomers, of which the first monomer is selected from the group consisting of monoesters or diesters of α,β-ethylenically unsaturated monocarboxylic or dicarboxylic acids with alkanols, of vinyl esters or of vinylaromatics, and the second monomer is an α,β-ethylenically unsaturated compound which has a group which is reactive with aldehydes in an alkaline medium, and comprising b) at least one stabilizer, and also c) at least one cycloaliphatic hydrocarbon having two to six aldehyde groups.

2. The polymer dispersion of claim 1, characterized in that the first monomer is selected from the group consisting of esters of acrylic acid with C₁-C₈ alkanols, esters of methacrylic acid with C₁-C₈ alkanols, vinylaromatics, vinyl esters of saturated C₁-C₄ carboxylic acids or combinations of two or more of these monomers, and in that the second monomer is selected from the group consisting of ethylenically unsaturated monomers comprising an acetoacetonate group or those comprising an imidazolinone radical or a urea radical.

3. The polymer dispersion of claim 1, characterized in that the film-forming polymer is selected from the group consisting of copolymers derived from one or more vinyl esters and the second monomer, copolymers of vinyl esters with esters of α,β-ethylenically unsaturated C₃-C₈ monocarboxylic or dicarboxylic acids with C₁-C₈ alkanols with the second monomer, copolymers of vinyl esters with olefins and the second monomer, copolymers of vinyl esters, ethene, esters of α,β-ethylenically unsaturated C₃-C₈ monocarboxylic or dicarboxylic acids with C₁-C₈ alkanols and the second monomer, copolymers of esters of acrylic acid and/or methacrylic acid with the second monomer, copolymers of styrene with butadiene and with the second monomer, copolymers of styrene with esters of α,β-ethylenically unsaturated C₃-C₈ monocarboxylic or dicarboxylic acids with C₁-C₈ alkanols and with the second monomer.

4. The polymer dispersion of claim 3, characterized in that the copolymer is selected from the group of vinyl acetate-derived copolymers with the second monomer, copolymers of vinyl esters with esters of acrylic acid and/or methacrylic acid and/or fumaric acid and/or maleic acid with C₁-C₈ alkanols and the second monomer, copolymers of vinyl acetate with ethylene and the second monomer, copolymers of vinyl esters, ethylene, and esters of acrylic acid and/or methacrylic acid and/or fumaric acid and/or maleic acid with C₁-C₈ alkanols and the second monomer, copolymers of esters of acrylic acid and/or methacrylic acid with the second monomer, copolymers of styrene with butadiene and the second monomer, and copolymers of styrene with esters of acrylic acid and/or methacrylic acid with C₁-C₈ alkanols and the second monomer.

5. The polymer dispersion of claim 1, characterized in that the film-forming polymer is a vinyl ester copolymer which derives from vinyl acetate, a vinyl ester of saturated branched monocarboxylic acids having 5 to 15 carbon atoms in the acid radical, the second monomer, and, if desired, ethylene, the fraction of vinyl ester units in the copolymer being at least 50% by weight.

6. The polymer dispersion of claim 1, characterized in that the film-forming polymer is an acrylic ester or methacrylic ester copolymer which derives from acrylic ester and/or methacrylic ester, the second monomer, and, if desired, styrene, the fraction of acrylic ester and methacrylic ester units in the copolymer being at least 50% by weight.

7. The polymer dispersion of claim 1, characterized in that the second monomer is selected from the group of ethylenically unsaturated monomers comprising a 1,3-diketo group, preferably an aceto-acetyl group, or ethylenically unsaturated monomers comprising an imidazolinone radical, or ethylenically unsaturated monomers comprising a urea radical.

8. The polymer dispersion of claim 7, characterized in that the second monomer is selected from the group consisting of compounds of the formulae Ia, Ib, Ic, and Id 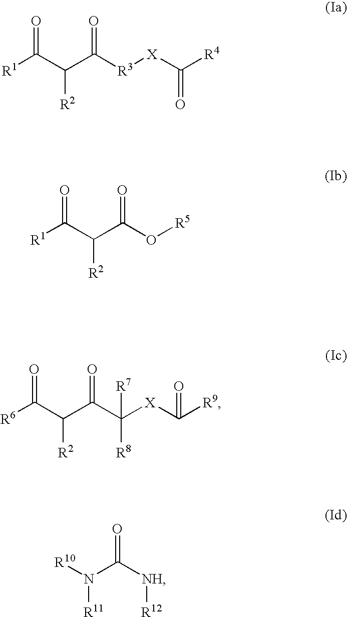
in which R¹ is a C₁-C₅ alkyl radical, preferably methyl,
R² is a C₁-C₅ alkyl radical or, preferably, hydrogen,
R³ is a C₁-C₅ alkylene radical, and
R⁴ is the radical of an ethylenically unsaturated organic carboxylic acid after the removal of the carboxyl group, preferably a radical of acrylic acid or of methacrylic acid following removal of the carboxyl group,
X is oxygen or NR¹³, with R¹³ being hydrogen or C₁-C₅ alkyl,
R⁵ is vinyl or allyl,
R⁶ is a C₁-C₅ alkyl radical, preferably methyl,
R⁷ and R⁸ independently of one another are hydrogen or a C₁-C₅ alkyl radical, preferably in each case methyl,
R⁹ is a radical of an ethylenically unsaturated organic carboxylic acid after the removal of the carboxyl group, preferably a radical of acrylic acid or methacrylic acid following removal of the carboxyl group,
R¹⁰ is a monoethylenically unsaturated radical having 2-20 C atoms, and
R¹¹ and R¹² independently of one another are hydrogen or C₁-C₅ alkyl or together form a C₂-C₄ alkylene group which is unsubstituted or substituted once or twice by C₁-C₅ alkyl, C₁-C₄ alkoxy and/or hydroxyl.

9. The polymer dispersion of claim 8, characterized in that the second monomer is selected from the group consisting of allyl acetoacetate, vinyl acetoacetate, acetoacetoxyethyl acrylate or acetoacetoxyethyl methacrylate.

10. The polymer dispersion of claim 1, characterized in that the film-forming copolymer comprises monomer units which derive from ethylenically unsaturated monomers comprising hydroxy-functional groups and/or from ethylenically unsaturated monomers comprising crosslinkable carbonyl groups and/or ethylenically unsaturated monomers comprising silane groups and/or ethylenically unsaturated monomers comprising epoxide groups.

11. The polymer dispersion of claim 1, characterized in that the polymer dispersion comprises at least one protective colloid, preferably hydroxy-ethylcellulose and/or polyvinyl alcohol.

12. The polymer dispersion of claim 1, characterized in that the polymer dispersion comprises a multistage polymer.

13. The polymer dispersion of claim 1, characterized in that it is a multicomponent composition having components A) and B), component A) being an aqueous dispersion having a pH of more than 7 and comprising film-forming polymer and the protective colloid and/or the emulsifier, and component B) comprising at least one cycloaliphatic hydrocarbon having two to six aldehyde groups.

14. The polymer dispersion of claim 1, characterized in that the cycloaliphatic hydrocarbon having two to six aldehyde groups is a cycloaliphatic dialdehyde of the formulae II to X or a mixture of two or more of these compounds

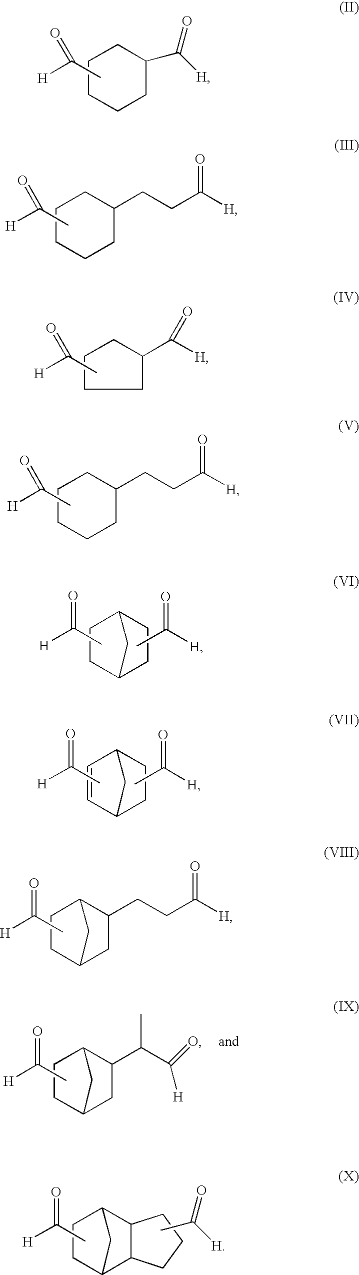

15. The polymer dispersion of claim 1, characterized in that it comprises at least one additive selected from the group consisting of film-forming assistants for lowering the minimum film formation temperature, plasticizers, buffers, pH modifiers, dispersants, defoamers, fillers, dyes, pigments, silane coupling agents, thickeners, viscosity regulators, solvents, preservatives and/or external cross linking agents.

16. The polymer dispersion of claim 1, characterized in that it comprises at least one external crosslinking agent.

17. The polymer dispersion of claim 13, characterized in that at least component A) has a pH of 7.1 to 14.

18. The polymer dispersion of claim 13, characterized in that the composition comprising component A) and comprising component B) has a pH of less than or equal to 7.0 and is adjusted by a pH modifier to a pH of greater than 7.0.

19. A curable composition obtainable by evaporating the water from the polymer dispersion of claim 1.

20. A cured composition obtainable by curing the curable composition of claim 19.

21. A coating composition comprising the polymer dispersion of claim 1 and also pigments and/or fillers.

22. The use of the polymer dispersion of claim 1 for producing coating compositions for coating substrates of all kinds.

23. The use of the coating compositions of claim 21 as synthetic-resin-bound plasters, tile adhesives, sealants, and sealing compounds, and also as paper-coating slips or as paints.

24. The use of the coating compositions of claim 23 as emulsion paints, dispersion-based varnishes or as stains.

25. The use of the coating compositions of claim 21 as roof coatings, as masonry paints or as interior paints.
